(19) United States
(12) Patent Application Publication
(10) Pub. No.: US 2018/0183858 A1
(43) Pub. Date: Jun. 28, 2018

(54) Method and System for Managing Cloud Based Operations

(71) Applicant: BeBop Technology LLC, Encino, CA (US)

(72) Inventors: Bruce Kevin Long, Woodland Hills, CA (US); David Scott Benson, Sherman Oaks, CA (US); Elon David Avisar, Encino, CA (US); Simranjit Singh Butalia, Porter Ranch, CA (US)

(21) Appl. No.: 15/393,164

(22) Filed: Dec. 28, 2016

(51) Int. Cl. H04L 29/08

(52) U.S. Cl. CPC H04L 67/10

(57) ABSTRACT

Computing resources 202, from a cloud computing network 200, are adjusted for a virtualized operation. Data comporting to the computing sources 202 and metrics of the virtualized operation are received and compared against the parameters that are associated with the virtualized operation. When the data and metrics fall outside of the parameters, the virtualized operation and the computing resources 202 can be adjusted to make the use of cloud computing system 200 and resources be used more efficiently.

### FIELD OF THE INVENTION

The Invention relates to the field of computers used to implement cloud-based processes, more specifically the efficient management of processes that take place in cloud networks.

### BACKGROUND OF THE INVENTION

In the development of computer and networking technologies, there is a progression for the implementation of computer systems being implemented from premises of a company or a user's home to what is called the cloud. That means that instead of having to update the physical hardware of a computer system every couple of years, cheaply purchaed computers can access remotely located computing services through a publicly or privately computer network.

The operation of a cloud based computer system does not always require the allocation of fixed processors, servers, and storage in order to implement applications and services. That is, when a company or a user needs to run a computer application, the computer resources used for running such an application can be allocated on demand. Hence, computing resources can be priced under a “pay as you go” model that are only paid for as needed which can be based on a fixed time unit (minute, hour, day, etc.) and/or on the number and type of computing resources being used (processors being used, storage allocated, etc.).

Although cloud computing offers many advantages, many of the devices that are cloud based tend to offer less features than a version of an application that can be run on an computer at a corporation's or user's premises. For example, trying to edit video in real time using cloud based video editing program tends to have a latency in performance and have less video editing options available for an editor than a computer running an editing program running on a local computer network. The same performance issues can exist for other types of applications such as accounting software, word processing applications, picture editing software, and the like.

### SUMMARY OF THE INVENTION

According to an aspect present disclosure, a method for receiving data comporting to a computing resource and a virtual operation being executed by the computing resource is described. There is a determination made about whether the data for both the computing resource and the virtual operation are within standard parameters whereby a notification and/or an adjustment to the computing resource and virtual operation can be made automatically.

According to another aspect of the present disclosure, an apparatus of a processor and a memory containing computer executable code are described and are used to execute the operations of receiving data comporting to a computing resource and a virtual operation being executed by the computing resource is described. There is a determination made about whether the data for both the computing resource and the virtual operation are within standard parameters whereby a notification and/or an adjustment to the computing resource and virtual operation can be made automatically.

### BRIEF DESCRIPTION OF THE DRAWINGS

These, and other aspects, features and advantages of the present disclosure will be described or become apparent from the following detailed description of the described exemplary embodiments, which is to be read in connection with the accompanying drawings.

In the drawings, wherein like reference numerals denote similar elements throughout the views:

FIG. 1 shows a block diagram of an exemplary embodiment of a computing system for operating a virtualized operation.

FIG. 2 shows a block diagram of an exemplary embodiment of a cloud based computing system.

FIG. 3 shows a block diagram of an exemplary embodiment of a method to manage computing resource in view of the performance of a virtualized computing operation.

It should be understood that the drawing(s) is for purposes of illustrating the concepts of the disclosure and is not necessarily the only possible configuration for illustrating the disclosure.

### DETAILED DESCRIPTION OF THE INVENTION

It should be understood that the elements shown in the figures might be implemented in various forms of hardware, software or combinations thereof. Preferably, these elements are implemented in a combination of hardware and software on one or more appropriately programmed general-purpose devices, which may include a processor, memory and input/output interfaces. Herein, the phrase “coupled” is defined to mean directly connected to or indirectly connected with through one or more intermediate components. Such intermediate components may include both hardware and software based components.

The present description illustrates the principles of the present disclosure. It will thus be appreciated that those skilled in the art will be able to devise various arrangements that, although not explicitly described or shown herein, embody the principles of the disclosure and are included within its scope.

All examples and conditional language recited herein are intended for pedagogical purposes to aid the reader in understanding the principles of the disclosure and the concepts contributed by the inventor to furthering the art, and are to be construed as being without limitation to such specifically recited examples and conditions.

Moreover, all statements herein reciting principles, aspects, and embodiments of the disclosure, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

Thus, for example, it will be appreciated by those skilled in the art that the block diagrams presented herein represent conceptual views of illustrative circuitry embodying the principles of the disclosure. Similarly, it will be appreciated that any flow charts, flow diagrams, state transition diagrams, pseudocode, and the like represent various processes which may be substantially represented in computer readable media and so executed by a computer or processor, whether or not such computer or processor is explicitly shown. The computer readable media and code written on can be implemented in a transitory state (signal) and a non-transitory state (tangible medium such as CD-ROM, DVD, Blu-Ray, Hard Drive, flash card, or other type of tangible storage medium).

The functions of the various elements shown in the figures may be provided through the use of dedicated hardware as well as hardware capable of executing software in association with appropriate software. When provided by a processor, the functions may be provided by a single dedicated processor, by a single shared processor, or by a plurality of individual processors, some of which may be shared. Moreover, explicit use of the term “processor” or “controller” should not be construed to refer exclusively to hardware capable of executing software, and may implicitly include, without limitation, digital signal processor (“DSP”) hardware, read only memory (“ROM”) for storing software, random access memory (“RAM”), and nonvolatile storage.

Other hardware, conventional and/or custom, may also be included. Similarly, any switches shown in the figures are conceptual only. Their function may be carried out through the operation of program logic, through dedicated logic, through the interaction of program control and dedicated logic, or even manually, the particular technique being selectable by the implementer as more specifically understood from the context.

In the claims hereof, any element expressed as a means for performing a specified function is intended to encompass any way of performing that function including, for example, a) a combination of circuit elements that performs that function or b) software in any form, including, therefore, firmware, microcode or the like, combined with appropriate circuitry for executing that software to perform the function. The disclosure as defined by such claims resides in the fact that the functionalities provided by the various recited means are combined and brought together in the manner which the claims call for. It is thus regarded that any means that can provide those functionalities are equivalent to those shown herein.

In the defined description, various exemplary embodiments are described in relation to what is called cloud or networking computing where examples of cloud computing implementations include Amazon Web Services (AWS), Microsoft Azure, IBM SoftLayer, Google Cloud, Vodafone Cloud Computing, and like. A computing resource such as a computer, one or more central processing units, one or more graphical processing units, storage, and the like are available through the use of a private or public communication network. The computing resource is initialized to run a computing instance where a number of computing resources (processors, storage, speed of the processors, cores of the processors, and the like) are used to enable to operation of the computing instance. A computing instance can be the delivery of a web enabled service such as a website running on the computing instance.

A computing instance can also be the virtualization of an program where the computing resources are performing some type of emulation of an operating system such as Microsoft Windows, Macintosh OS, Linux, Android OS, and the like. That is, the computing resource is performing a virtualization operation where an application such as a video/film editing program, accounting software, graphics application, word processing software, medical imaging software, engineer simulation software, and the like is being run in a virtual environment as a virtual desktop interface (VDI) such as VMware, Teradici, and the like where the application is being executed in an native operating system for the application, even though the operating system is being emulated by the computing resource.

Moreover, by having computing resources located remotely, an application being virtualized for a particular OS may be able to take advantage of more computing resources than if run locally in a personal computer. This benefit can also be true if the application being used is a graphics effects program such as Adobe After Effects, Autodesk Smoke, Avid Media Composer with a Visual Effects module, and the like that can use a large number graphical processing units that are located remotely in a cloud based resource than may be available locally to a personal computer running the same operation. The presented embodiments can make use of these “rendering farms” of remote computing resource while running a more powerful version of an graphics effects program that is run in a web browser without virtualization. Other application types can benefit from these exemplary principles as well.

The described exemplary embodiments can also be implemented to apply to computing instances called containers such as Docker where a virtualized operation is considered to be in its own unique “container” in a cloud computing environment. These containers can be run independently of each other where different types of applications and computer operations can be run in each of these containers. By using a series of containers, the cloud computing system does not need to always virtualize a whole operating system as when using VDI, where a necessary computing component that is needed can be spun up and ramped down based on application's need of memory, processing, graphics functions, registry operations, and the like.

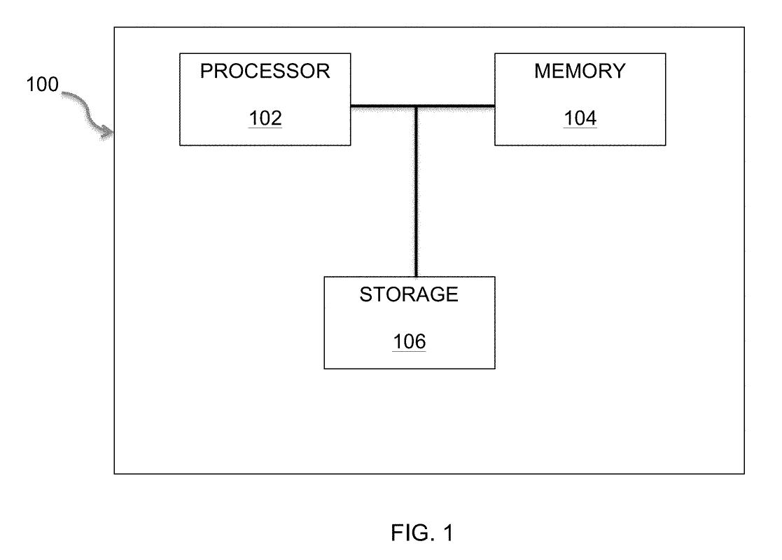

In FIG. 1, a block diagram of an exemplary computing system 100 is described. Processor 102 a single or multiple processors that are used to execute computer code which can be an operating system, application, other types of software and the like. Processor 102 can be a central processing unit, a graphical processing unit, an application specific integrated circuit (ASIC), microprocessor, a processor enabled to run cloud based computing applications, multi-processing core, and the like. Processor 102 also be configured to output information that can be rendered as audio, video, as a user interface data, text, or a combination thereof by processor 102 itself, a video processor, audio processor, display device, and the like. Data can also be outputted by processor 102 that is related to the operation of an application, computing resource, virtualization operation, and the like. Processor 102 can be configured to handle communications between other computing systems 100, client devices being run at a customer's premises, remote servers, local servers, and the like.

Memory 104 contains computer code that can be an operating system, application, or other types of software where the code is executed by processor 102. Memory 104 can be a read only memory (ROM), a random access memory (RAM), dynamic random access memory (DRAM), static random access memory (SRAM), volatile memory, non-volatile memory, and the like.

Storage 106, which can be coupled to processor 102 and memory 104, can be used to store computer code, application data, application files such as audio, video, and text, computer files, operating system information, and the like. Processor 102 can access storage 106 to execute and save data when various applications and operations are performed. Storage 106 can be disc storage, solid state storage, a compact disc, Blu-ray disc, optical storage, hard drive(s), a blade server, magnetic based storage, and the like.

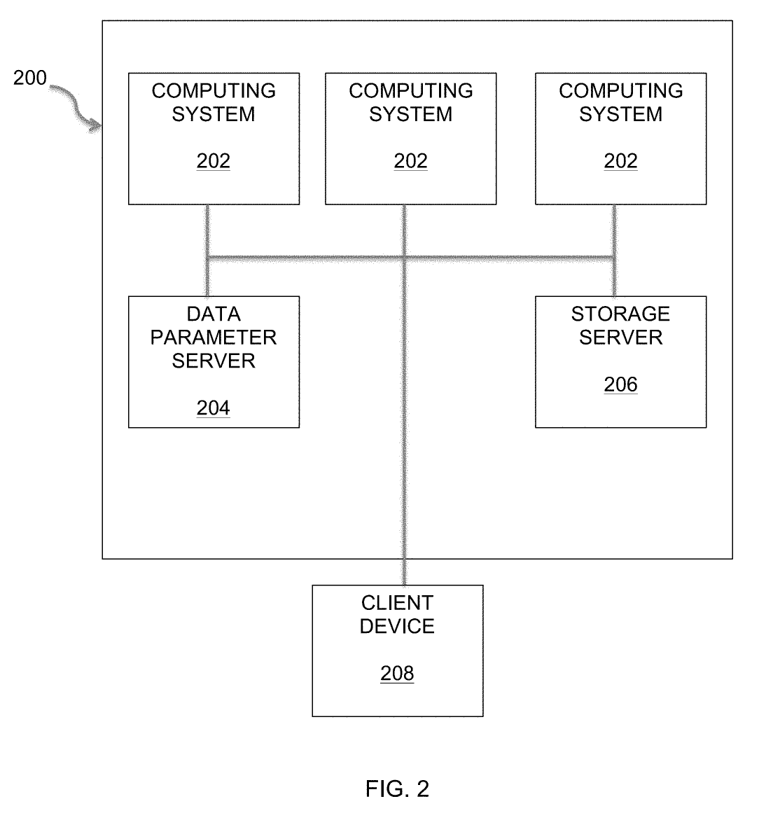

FIG. 2, a block diagram of an exemplary embodiment of a cloud based computing system 200 is shown. Specifically, cloud based computing system 200 comprises a series of computing resources such as computer systems 202 that can be configured in accordance with the description given above. Computing systems 202 can be enabled to operate as a single operating resources when running an application, can be enabled to run together as to provide multiple processors, memory, storage components, and the like, and in any other configuration required to enable an application such as software as a service, a virtualized application, and the like. In some exemplary embodiments, a particular computer system 202 can be used to configure the required computing resources from cloud based computing system 200 required to enable an application, virtualized application, software as a service, and the like where a number of parameters such as number of processors used, speed of the processors, the number of cores allocated, memory requirements for the application, storage to operate an application, storage required to store data files, and the like.

Data parameter server 204 is a server configured to contain data that is related to the operation of the applications, virtualized operations, and computing resources that are used by cloud computing system 200. The computing resource data, which can come from computing system 202, can be number of different parameters including central processing unit speed, graphical processing unit speed, number of central processing units being used, a number of graphical processing unit being used, amount of storage being used as a computing resource, amount of solid state storage being used, amount of disc storage being used, number of central processing units cores being used, number of graphical processors unit cores being used, speed of a network coupled to computing resources, location of various computing resource, and the like. Data parameter server 204 can also be configured to store and receive data about metrics, from computing system 202, related to the operation of a virtualized application which can include amount of time to perform a virtualized operation by a computer/computing resource, amount of time a user is using to perform a task using said virtualized operation, amount of time a user is using said virtualized operation, amount of financial resources allocated for the performance of the virtualized operation, a financial budget allocated for the performance of the virtualized operation, resources (e.g., how many people are working on a project, amount of money spent on a project, amount of time spend on a project, and the like) allocated to a project being managed by the virtualized operation, and the like.

Data parameter server 204 can be configured to monitor the generated data (first set of values) and metrics (second set of values) from computing system(s) 202 to determine if such values are within specified parameters of computing resources and metrics for a particular virtualized operation. For example, if video editing program is being virtualized by cloud computing system 200, data related to computing resources such as the number of processors being allocated for the operation, the speed of the processing units, the amount of memory for the virtualized operation, and the like would be specified in a particular range. In addition, the metrics of the virtualized operation such as the amount of time it takes to render a scene of video at a particular resolution can also be stored by data parameter 204. Different virtualized applications will have different metrics and computing resources data ranges.

It is noted that the specific aspects of computing resources and virtualized application are being changed as to make the cloud based computing system 200 run more efficiently, in some exemplary embodiments, where sometimes more resources are required to make a system work faster for a virtualized operation and sometimes resources are removed because they are not being used for a virtualized operation. The efficient use of resources can also be useful, in some other exemplary embodiments, where the amount of money being spent in the operation of a cloud based computing system 200 are better managed because the use of unnecessary computing resources can be eliminated which is important for a pay as you go system (an entity pays for the amount of time, processors, and storage being used).

Computing system 200 can also generate a real time notification (in the form of a user interface and/or text in some exemplary embodiments) if the values of the computing resource data and/or the virtual operation metrics are not within a specified range of parameters which can be sent to an external device such as client device 208 through a communication network. Exemplary notifications can tell a user that the amount of computing resource will be changed, that a particular operation being run by a user for a virtualized operation are taking too long, that more storage or processors should be allocated (which may need to be paid for by a user)

Based on the whether or not particular ranges of data and metrics are being maintained for a particular virtualized operation as specified in data parameter server 204, a computing system 202 can change features of the computing resources being used and/or change a parameter associated with the virtualized operation. These changes can be made by computing system 202 until the various computing resource data and metrics are within specified parameters. Examples of various changes that can be made to computing resources can be automatically adding at least one central processor to execute said virtualized operation, automatically removing at least one central processor to execute said virtualized operation automatically adding at least one graphics processing unit to execute said virtualized operation, automatically removing at least one graphics processing unit to execute said virtualized operation, automatically adding memory to execute said virtualized operation, automatically removing memory to execute said virtualized operation, automatically adding storage to execute said virtualized operation, automatically removing storage to execute said virtualized operation.

Other examples of changes that can be made to computing resources by computing system 202 can be increasing a speed of a central processing unit to execute said virtualized operation, decreasing a speed of a central processing unit to execute said virtualized operation, increasing a speed of at least one graphical processing unit executing said virtualized operation, decreasing a speed of at least one graphical processing unit executing said virtualized operation, adding more central processing unit core units to execute said virtualized operation, removing central processing unit core units to execute said virtualized operation, adding more graphical processing unit core units to execute said virtualized operation, removing graphical processing unit core units to execute said virtualized operation, increasing more cloud computing resources executing said virtualized operation, and decreasing cloud computing resources executing said virtualized operation, and the like.

Storage server 206 can be a disc based, solid state, magnetic based, and the like which is used by computing systems 202 to store applications, application data, OS data, cloud computing data, audio data, video data, textual data, and the like. Client device 208, which communicates with cloud computing system 200 through a communication network (public/private), can be a personal computer, a smartphone, a tablet, a server, a gaming system, a video capture device, an audio capture device, and the like. In an exemplary embodiment, client device 208 receives graphical data over a PCoIP protocol (from Teradici) presenting the virtualized operation and such data is rendered on such a device. Client device 208 communicates with cloud computing system 200 through a communication network that can be public and/or private, and such communications can be managed computing system 202. Other configurations of cloud computing system 200 and client device 208 can be implemented in accordance with the described exemplary embodiments.

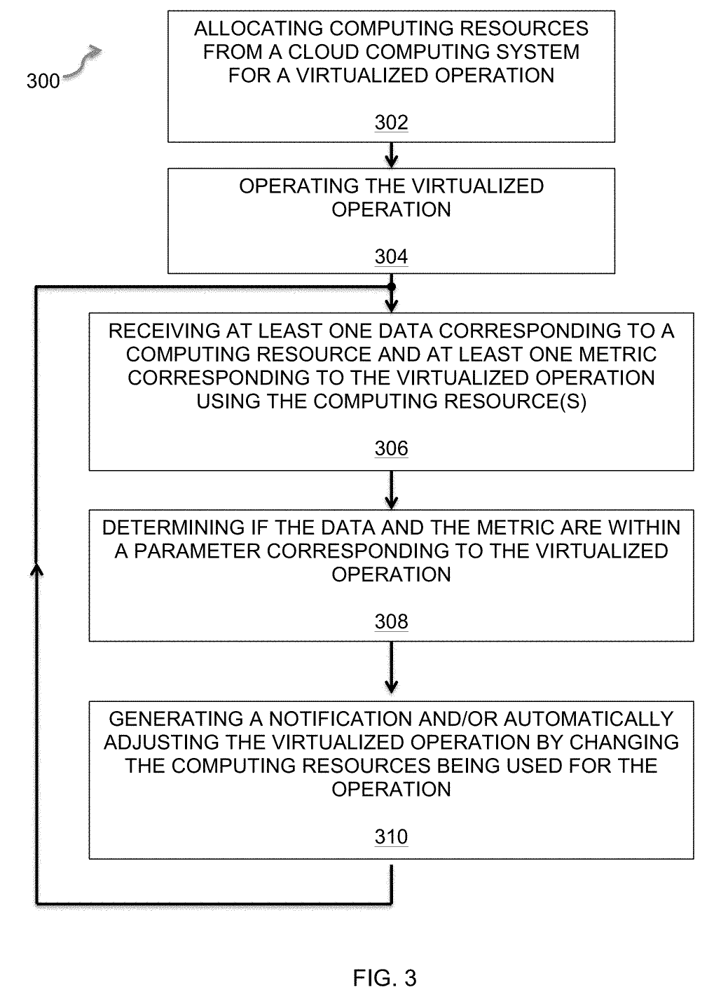

FIG. 3 shows a block diagram of a method 300 to manage computing resource in view of the performance of a virtualized computing operation in accordance with an exemplary embodiment. Specifically, method 300 is expected to be executed by a processor(s) 102 within a computing system 100, 202 by executing various computer code stored in memory 104 as referenced in FIGS. 1 and 2. Step 302 begins with computing system 100, 202 allocating specific computing resources from a cloud computing system 200 for a virtualized operation. This step can be performed by having computing system 100, 202 reference parameter server 204 to determine what computing resources should be allocated in some exemplary embodiments. In other cases, computing system 100, 202 can receive instructions from a user allocating the various computing resources. Other mechanisms can be used for such an allocation in accordance with the described principles. The determination of what virtualized operation to perform can be done in view of an automatic instruction, an instruction received from a user device, and the like.

In step 304, computing system 100, 202 executes instructions to initiate and operate a specified virtualized operation whereby the operation is run. During the performance of the virtualized operation, various data corresponding to computing resources being used and various metrics about the virtualized operation are generated the computing system 100, 202 running such an operation. In step 306, the data related to the computing resources and the metrics of the virtualized operations are received by computing system 100, 202. These values can be generated internally or received from another computing system 100,202 if the virtualized operation is being performed by another computing system 100, 202 in accordance with various exemplary embodiments.

Method 300 continues with the performance of step 308 where computing system 100, 202 does a determination if the computing resources data and virtualized operations metrics are within certain parameters allocated for the virtualized operation. Such parameter information can be obtained from data parameter server 204 as described above. Different virtualized operations will have different values sets allocated for computing resources and the virtualized operation itself.

Based on the results of the previous step (308), in step 310 computing system 100, 202 can generate a data comprising a notification which can be sent to a client device 208 indicating whether or not the computing resource data and/or virtual operation metrics are within parameters. If such parameters are not acceptable, computing system 100, 202 can automatically adjust the virtualized operation by changing the computing resources being used, as described above in exemplary embodiments, and/or can change how the virtualized operation is being implemented by adding or removing various application features. Such adjustments can be performed by adding more computing resources to execute the virtualized operation in a faster manner, for example, in some exemplary embodiments.

Optionally, steps 306, 308, and 310 can be repeated on a periodic basis to make sure the available resources are being used efficiently, in accordance with the described exemplary principles.

In an optional embodiment, the implementation of the system can utilize operational code that is designed to pause the operation of a virtualized operating system and/or an underlying system so resources can be changed to support various applications. One approach for supporting the reallocation of resources to be changed can be is the development of a mapping table that is used by a server to keep track of the applications and memory locations that are being used before a readjustment of resources is made. Other approaches can be used in accordance with the described principles.

1. A method comprising:
receiving at least one data corresponding to a computing resource and at least one metric corresponding to a virtualized operation using said computing resource;
determining if said at least one data and said at least one metric are within a parameter corresponding to said virtualized operation; and
generating data comprising a notification based on said determining operation.

2. The method of claim 1 wherein said virtualized operation is automatically adjusted when said at least one data and said at least one metric are not within said parameter.

3. The method of claim 2 wherein said adjustment is automatically applied until said at least one data and said at least one metric are within said parameter.

4. The method of claim 2 wherein said virtualized operation is adjusted as to add more of said at least one computing resource as to execute said virtualized operation as to run faster.

5. The method of claim 4 wherein said adding of more of said at least one computing resource is selected from the group comprising: automatically adding at least one central processor to execute said virtualized operation, automatically removing at least one central processor to execute said virtualized operation automatically adding at least one graphics processing unit to execute said virtualized operation, automatically removing at least one graphics processing unit to execute said virtualized operation, automatically adding memory to execute said virtualized operation, automatically removing memory to execute said virtualized operation, automatically adding storage to execute said virtualized operation, automatically removing storage to execute said virtualized operation, increasing a speed of a central processing unit to execute said virtualized operation, decreasing a speed of a central processing unit to execute said virtualized operation, increasing a speed of at least one graphical processing unit executing said virtualized operation, decreasing a speed of at least one graphical processing unit executing said virtualized operation, adding more central processing unit core units to execute said virtualized operation, removing central processing unit core units to execute said virtualized operation, adding more graphical processing unit core units to execute said virtualized operation, removing graphical processing unit core units to execute said virtualized operation, increasing more cloud computing resources executing said virtualized operation, and decreasing cloud computing resources executing said virtualized operation

6. The method of claim 1 wherein said parameter is a set of values where a first set of values applies for said computing resource and a second set of values applies for said virtualized operation.

7. The method of claim 1 wherein said at least one data is selected from the group comprising: a central processing unit speed, graphical processing unit speed, a number of central processing units being used, a number of graphical processing units being used, amount of storage being used as a computing resource, amount of solid state storage being used, amount of disc storage being used, a number of central processing unit cores being used, and a number of graphic processing unit cores being used, a speed of a network coupled to said computing resource, and location of storage being used.

8. The method of claim 1 wherein said at least one metric is selected from the group comprising: amount of time to perform said virtualized operation by a computer, amount of time a user is using to perform a task using said virtualized operation, amount of time a user is using said virtualized operation, amount of financial resources allocated for the performance of said virtualized operation, a financial budget allocated for the performance of said virtualized operation, and resources allocated to a project being managed by the virtualized operation.

9. The method of claim 1 where said notification is in the form of a user interface.

10. The method of claim 1 where said notification is presented in real time.

11. An apparatus comprising:
at least one processor:
a memory containing computer code where executed by said processor performs operations:
receiving at least one data corresponding to a computing resource and at least one metric corresponding to a virtualized operation using said computing resource;
determining if said at least one data and said at least one metric are within a parameter corresponding to said virtualized operation; and
generating data comprising a notification based on said determining operation.

12. The apparatus of claim 11 wherein said virtualized operation is automatically adjusted when said at least one data and said at least one metric are not within said parameter.

13. The apparatus of claim 12 wherein said adjustment is automatically applied until said at least one data and said at least one metric are within said parameter.

14. The apparatus of claim 12 wherein said virtualized operation is adjusted by said apparatus to add more of said at least one computing resource as to execute said virtualized operation as to run faster.

15. The apparatus of claim 14 wherein said adding of more of said at least one computing resource is selected from the group comprising: automatically adding at least one central processor to execute said virtualized operation, automatically adding at least one graphics processing unit to execute said virtualized operation, automatically adding memory to execute said virtualized operation, automatically adding storage to execute said virtualized operation, increasing a speed of a central processing unit to execute said virtualized operation, increasing a speed of at least one central processing unit executing said virtualized operation, increasing a speed of at least one graphical processing unit executing said virtualized operation, and increasing more cloud computing resources executing said virtualized operation.

16. The apparatus of claim 11 wherein said parameter is a set of values where a first set of values applies for said computing resource and a second set of values applies for said virtualized operation.

17. The apparatus of claim 11 wherein said at least one data is selected from the group comprising: a central processing unit speed, graphical processing unit speed, a number of central processing units being used, a number of graphical processing units being used, amount of storage being used as a computing resource, amount of solid state storage being used, amount of disc storage being used, a number of central processing unit cores being used, a number of graphic processing unit cores being used, a speed of a network coupled to said computing resource, and location of storage being used.

18. The apparatus of claim 11 wherein said at least one metric is selected from the group comprising: amount of time to perform said virtualized operation by a computer, amount of time a user is using to perform a task using said virtualized operation, amount of time a user is using said virtualized operation, amount of financial resources allocated for the performance of said virtualized operation, a financial budget allocated for the performance of said virtualized operation, and resources allocated to a project being managed by the virtualized operation.

19. The apparatus of claim 11 where said notification is in the form of a user interface.

20. The apparatus of claim 11 where said notification is presented in real time.
